(19) United States
(12) Patent Application Publication
(10) Pub. No.: US 2026/0154613 A1
(43) Pub. Date: Jun. 4, 2026

(54) METHOD AND SYSTEM FOR USING MACHINE LEARNING TO PREDICT CELL CHARACTERISTICS IN CIRCUIT DESIGN PROCEDURE

(71) Applicant: Realtek Semiconductor Corp., HsinChu (TW)

(72) Inventors: Yen-Tzu Chang, HsinChu (TW); Hsin-Chang Lin, HsinChu (TW); Chih-Ching Lin, HsinChu (TW)

(73) Assignee: Realtek Semiconductor Corp., HsinChu (TW)

(21) Appl. No.: 19/019,517

(22) Filed: Jan. 14, 2025

(30) Foreign Application Priority Data
Dec. 2, 2024 (TW) 113146499

(51) Int. Cl. G06N 20/00; G06F 30/367

(52) U.S. Cl. CPC G06N 20/00; G06F 30/367

(57) ABSTRACT

A method for using in a circuit design process includes: deriving information regarding a specific cell from a cell library; generating an initial dataset based on the information regarding the specific cell; constructing or optimizing a machine learning model based on the initial dataset; and generating one or more target characteristic data regarding the specific cell based on the constructed or optimized machine learning model.

### BACKGROUND OF THE INVENTION

### 1. Field of the Invention

The present invention relates to the field of circuit design, particularly to a method and system for using machine learning to predict cell characteristics in circuit design procedures.

### 2. Description of the Prior Art

In the field of integrated circuit design, accurately predicting and controlling cell leakage current is a critical challenge. Leakage current not only directly affects power consumption of integrated circuits but is also closely related to heat generation, which further affects performance, reliability, and lifespan of integrated circuits. However, leakage current has complex nonlinear relationships with various operating conditions and environmental factors (such as temperature), making it particularly difficult to accurately predict leakage current under different operating conditions and environments. Currently, leakage current estimation methods include two approaches: circuit simulation software, such as Simulation Program with Integrated Circuit Emphasis (SPICE) simulation method and linear interpolation method. Software simulation is relatively accurate, performing detailed circuit simulations by adjusting different parameter settings. However, this method has significant drawbacks, such as high time cost: each set of different settings requires initiating a complete simulation process, which can significantly extend the design cycle in large-scale integrated circuit design. On the other hand, linear interpolation method attempts to quickly estimate leakage current by interpolating from a limited number of sample points. While this method is computationally fast, its accuracy is lower for the following reasons: 1) ignoring nonlinear relationships: the relationship between leakage current and temperature is typically nonlinear, and linear interpolation cannot accurately capture these complex relationships; 2) sample limitations: available sample points are usually limited, which restricts the accuracy of interpolation, especially in regions outside the sample points.

Furthermore, cell library limitations exacerbate this problem. Cell libraries provided by vendors typically contain only a limited number of leakage current data points, which are often insufficient to cover all operating conditions that integrated circuits may encounter in practical applications. Particularly when conducting thermal analysis, accurate leakage current data is needed at multiple temperature points, which exceeds the range provided by cell libraries.

This situation forces designers to make trade-offs between accuracy and efficiency. Using software for comprehensive simulation can achieve highly accurate results but at the cost of long simulation times. Using fast but less accurate linear interpolation methods may lead to significant errors in thermal analysis and power consumption estimation, thereby affecting the overall quality and reliability of circuit design. Therefore, there is an urgent need in this field for an innovative method that can accurately predict cell leakage current under different operating conditions without excessively increasing computational complexity.

### SUMMARY OF THE INVENTION

In view of the challenges in predicting cell leakage current in integrated circuit design, the present invention provides an innovative method and system. The core of the present invention is to construct a data analysis model (such as a machine learning model) that can accurately simulate the complex nonlinear relationships between leakage power consumption and multi-dimensional parameter space (including operating condition parameters and state parameters). The present invention not only considers operational factors such as cell temperature but also incorporates potentials of all input terminals of the cell as state features, thus providing more comprehensive prediction of leakage behavior. Moreover, the present invention generates an initial dataset based on limited information provided by the cell library, and through model training and optimization, enables the generation of leakage power predictions covering extensive operating conditions and state parameters based on limited known data. Through these features, the present invention enables integrated circuit designers to conduct more accurate power consumption assessment and optimization during the design phase.

According to one embodiment, a method for using in a circuit design process is provided. The method comprises: deriving information regarding a specific cell from a cell library; generating an initial dataset based on the information regarding the specific cell; constructing or optimizing a machine learning model based on the initial dataset; and generating one or more target characteristic data regarding the specific cell based on the constructed or optimized machine learning model.

According to one embodiment, a system for using in a circuit design process is provided. The system comprises: a processor and a memory for storing multiple instructions. When the multiple instructions are executed by the processor, the system performs the following operations: deriving information regarding a specific cell from a cell library; generating an initial dataset based on the information regarding the specific cell; constructing or optimizing a machine learning model based on the initial dataset; and generating one or more target characteristic data regarding the specific cell based on the constructed or optimized machine learning model.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a method for using in a circuit design process according to one embodiment of the present invention.

FIG. 2 illustrates a schematic diagram of a system for using in a circuit design process according to one embodiment of the present invention.

FIG. 3 illustrates an initial dataset and an expanded characteristic dataset according to one embodiment of the present invention.

FIG. 4 illustrates a flowchart a method for using in a circuit design process according to another embodiment of the present invention.

### DETAILED DESCRIPTION

In the following description, numerous specific details are set forth to provide readers with a thorough understanding of the embodiments of the present invention. However, those skilled in the art will understand how to implement the present invention without one or more specific details, or by using other methods, components, or materials. In other cases, well-known structures, materials, or operations are not shown or described in detail to avoid obscuring the core concepts of the present invention.

Reference throughout this specification to “an embodiment”, “one embodiment” or “some embodiments” means that particular features, states, or characteristics described in connection with that embodiment(s) may be included in at least one embodiment of the present invention. Therefore, appearances of the phrases “in an embodiment”, “in one embodiment” or “in some embodiments” in various places throughout this specification does not necessarily all referring to the same embodiment(s). Furthermore, the particular features, states, or characteristics mentioned above may be combined in any suitable combinations and/or sub-combinations in one or more embodiments.

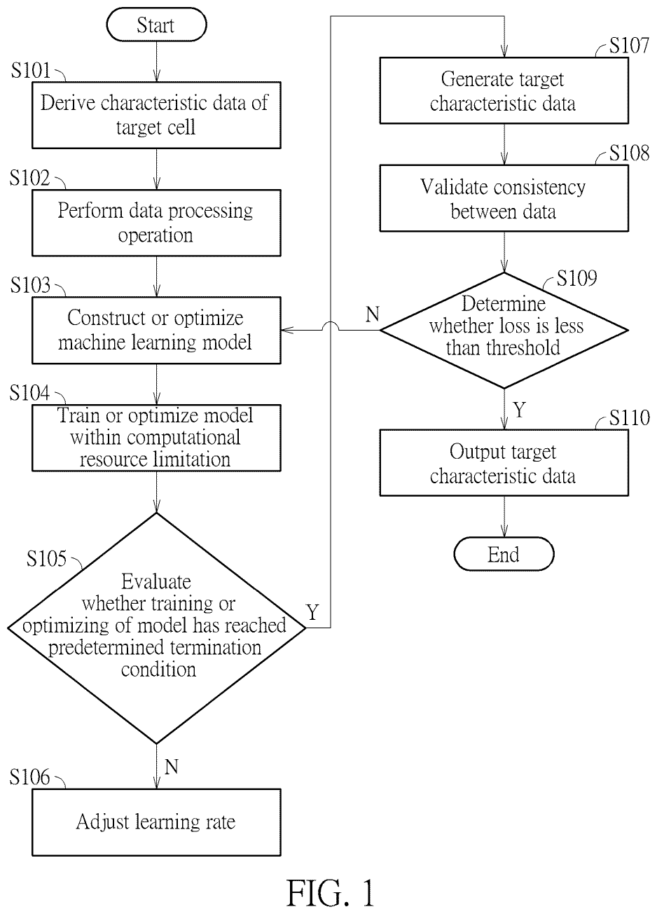

Please refer to FIG. 1, which illustrates a flowchart of a method for using in a circuit design process according to one embodiment of the present invention. At step S101, multiple characteristic data corresponding to multiple operating condition parameter values of at least one operating condition and/or multiple state parameter values of at least one state parameter of a target cell are obtained to serve as an initial dataset. That is, at step S101, characteristic data corresponding to multiple operating condition parameter values of the at least one operating condition of the target cell are derived from and/or characteristic data corresponding to multiple state parameter values of at least one state parameter of the target cell are derived from a cell library, to generate the initial dataset. More specifically, the at least one operating condition can be an operating temperature of the target cell, the at least one state parameter can be potentials (voltage levels) of input terminals (such as signal pins, leads, pads, and various connection forms) of the target cell, the multiple operating condition parameter values can be multiple specific operating temperature values, the multiple state parameter values can be specific input terminal potential values, and the characteristic data can be leakage power corresponding to multiple operating temperature values and/or corresponding to multiple input terminal potential values (voltage levels). Furthermore, the cell library may contain predetermined data and characteristics of various different cells.

At step S102, one or more data processing operations are performed on data pairs in the initial dataset. In some embodiments, the one or more data processing operations include logarithmic processing and normalization processing. In some embodiments, the one or more data processing operations may also include various different types of nonlinear transformations. Please note that step S102 is optional in the flow of the present invention; in some embodiments, if range of value distribution of the characteristic data does not require processing or adjustment, step S102 can be skipped.

At step S103, a machine learning model is constructed or optimized. More specifically, at step S103, the machine learning model are constructed or optimized based on the initial dataset processed through step S102, or based on the initial dataset without being processed through step S102. On the other hand, if the machine learning model performs below expectations in subsequent validation processes, the flow may return back to step S103 to further optimize the machine learning model. In some embodiments, the machine learning model can be a sequential model with multi-layer structure. The multi-layer structure of the sequential model may include multiple dense layers, i.e., fully connected layers. Furthermore, the machine learning model is expected to capture relationships between specific operating conditions and/or state parameters and characteristic data.

At step S104, within a predetermined computational resource limitation, the machine learning model is trained or optimized to improve its fitness to the processed initial dataset (or unprocessed initial dataset). In some embodiments, the predetermined computational resource limitation may correspond to a step limit or an iteration limit (such as 500 steps or 500 iterations). In some embodiments, the predetermined computational resource limitation may correspond to a training time limit or an optimization time limit. Furthermore, the training or the optimization of the machine learning model includes model parameter adjustments. For example, adjustments related to parameters such as units, kernel initializer, bias initializer, and activation function settings. Moreover, if the machine learning model relies on the aforementioned sequential model structure, a weight matrix of a first dense layer can be randomly initialized using Gaussian distribution (i.e., random normal).

At step S105, it is evaluated whether a training process or an optimization process of the machine learning model has reached a predetermined termination condition. More specifically, it will be checked at step S105 whether the predetermined computational resource limitation has been reached. In some embodiments, it is checked at step S105 whether the training process or the optimization process has reached the step limit or the iteration limit. In some embodiments, it is checked at step S105 whether the training process or the optimization process has reached the training time limit or the optimization time limit. If the evaluation result at step S105 is negative (i.e., the predetermined termination condition has not been reached), the flow enters step S106. At step S106, a learning rate of the machine learning model is adjusted. In some embodiments, the learning rate may be adjusted in each step or in each iteration based on an exponential decay method or other possible learning rate adjustment methods. Alternatively, the learning rate may be adjusted every few steps or iterations. By adjusting the learning rate, the training or optimization efficiency of the machine learning model can be improved.

If the evaluation result at step S105 is positive (i.e., the predetermined termination condition has been reached), the flow enters step S107. At step S107, one or more target characteristic data are generated based on the constructed or optimized machine learning model. Furthermore, if the characteristic data corresponds to the leakage power of the target cell, one or more leakage power values corresponding to multiple operating condition parameter values and/or multiple state parameter values will be output at step S107. At step S108, consistency between the target characteristic data generated by the machine learning model and the processed initial dataset (or unprocessed initial dataset) is validated. In some embodiments, a loss (such as a loss function) between the target characteristic data and the processed initial dataset will be evaluated at step S108, for example, calculating the loss based on mean squared error (MSE), root mean squared error (RMSE), or mean absolute error (MAE), thereby quantifying the fitness between the target characteristic data and the processed initial dataset to determine the reliability and the accuracy of the machine learning model.

At step S109, it is determined whether the loss is lower than a predetermined value. Furthermore, the loss can be an error percentage between the generated target characteristic data and the initial dataset, or other error quantification indicators. It can be determined at step S109 whether the machine learning model meets expected accuracy requirements. If the determination result at step S109 is negative, the flow returns to step S103 to optimize the machine learning model. If the determination result of step S109 is positive, the flow enters step S110. At step S110, the generated target characteristic data is output to further generate an expanded characteristic dataset. More specifically, the expanded characteristic dataset covers relationships between characteristic data and a broader range of operating condition parameter values and/or state parameter values, or relationships between characteristic data and finer intervals of operating condition parameter values and/or state parameter values. The expanded characteristic dataset can be generated by integrating or merging the target characteristic data into the initial dataset and can be employed to further update the cell library, thereby enhancing the comprehensiveness and accuracy of existing data in the cell library. Moreover, the expanded characteristic dataset can also be applied in a circuit design process to accurately simulate overall circuit characteristics.

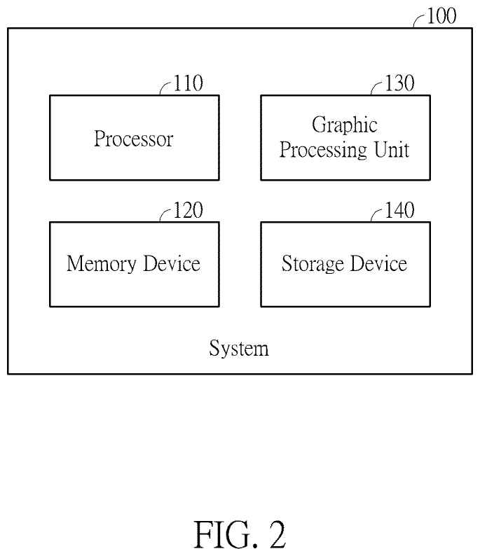

FIG. 2 illustrates a schematic diagram of a system for using in a circuit design process according to one embodiment of the present invention. As shown, a system 100 can be employed to execute the method shown by FIG. 1, thereby precisely predicting and generating characteristic data for individual cells and simulating overall circuit characteristics in the circuit design process. The system 100 can be designed with various hardware and software combinations focused on machine learning model training and optimization requirements. As shown in FIG. 2, the system 100 typically includes at least one processor 110 and one or more memory devices 120. Alternatively, for specialized machine learning tasks, the system 100 may employ application-specific integrated circuits (ASIC) or field-programmable gate arrays (FPGA). In some embodiments, the system 100 may employ graphics processing units (GPU) 130 to handle parallel processing tasks common in machine learning workloads. A memory subsystem of system 100 can include various hierarchies, such as: fast static random access memory (SRAM) for immediate data access; high bandwidth memory (HBM) for large-scale high-speed data transfer; and large-capacity dynamic random access memory (DRAM) for storing large quantities of model parameters and intermediate results. In advanced configurations, the system 100 may also incorporate a storage device 140, such as NVMe solid-state drives for fast storage and retrieval of large model files and datasets. The storage device 140 can be used to store cell libraries, initial datasets, and expanded characteristic datasets. During model constructing/training or optimization process, cell libraries, initial datasets, and expanded characteristic datasets can be loaded into one or more memory devices 120 to accelerate the processing and utilization of this data and information by processor 110 or GPU 130.

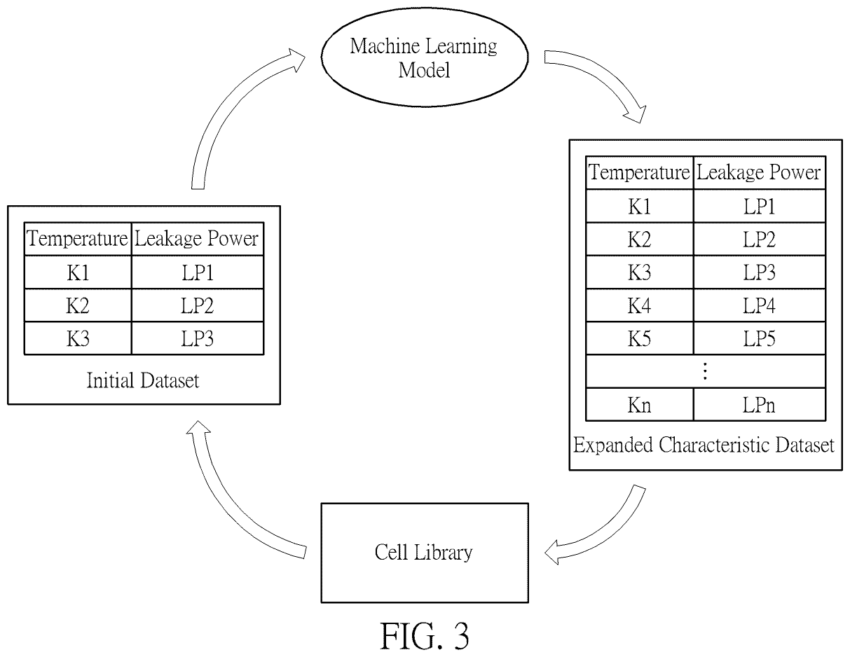

FIG. 3 illustrates an initial dataset and an expanded characteristic dataset according to one embodiment of the present invention. As shown, an initial dataset may include leakage power values LP1, LP2, and LP3 derived from a cell library for a specific cell at specific operating temperature values K1, K2, K3 (such as −40° C., 0° C., and 125° C.). Through the machine learning model constructed or optimized by the method of the present invention, it can further predict leakage power values LP4-LPn for the specific cell at specific operating temperature values K4-Kn. The specific operating temperature values K4-Kn can be any temperature values within a temperature range defined by the operating temperature values K1, K2, K3 (such as any temperature value between −40° C. and 125° C.), or any temperature values outside the temperature range defined by the operating temperature values K1, K2, K3 (such as any temperature value lower than −40° C. or greater than 125° C.), or both. The leakage power values LP4-LPn at specific operating temperature values K4-Kn can be merged or integrated with the initial dataset to produce the expanded characteristic dataset. The expanded characteristic dataset can be used to update information and data in the cell library, thereby being utilized in subsequent circuit design processes.

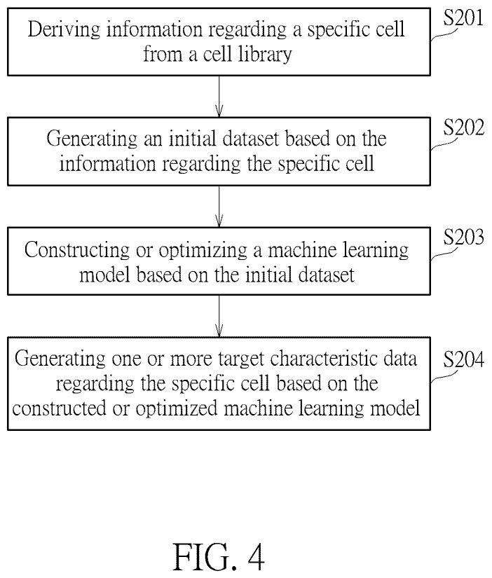

FIG. 4 illustrates a flowchart a method for using in a circuit design process according to another embodiment of the present invention. The flow shown in FIG. 4 can be viewed as a simplified version of the flow shown in FIG. 1, demonstrating crucial steps for implementing the concept of the present invention. As shown, the simplified version includes the following flow:
Step S201: deriving information regarding a specific cell from a cell library;
Step S202: generating an initial dataset based on the information regarding the specific cell;
Step S203: constructing or optimizing a machine learning model based on the initial dataset;
Step S204: generating one or more target characteristic data regarding the specific cell based on the constructed or optimized machine learning model.

Since the principles and details of the above steps have been explained in detail through the above embodiments, they will not be repeated here. It is worth noted that the above flow can be enhanced by adding other additional steps or making appropriate modifications and adjustments to better improve the reliability, accuracy, and efficiency of the simulation and analysis phases in a circuit design process.

In summary, the method and system provided by the present invention can be applied in integrated circuit design processes to accurately predict and optimize cell leakage power. The method of the present invention ingeniously combines high-precision nonlinear modeling techniques, enabling designers to quickly generate detailed leakage power estimates covering extensive variables based on limited known data. The present invention not only considers operational factors such as cell temperature but also incorporates cell state parameters, thus providing a more comprehensive and accurate description of leakage behavior. Through the present invention, integrated circuit designers can conduct more precise power consumption assessment and hotspot analysis in early design phases, significantly reducing design iteration cycles and markedly improving design efficiency. This not only accelerates product development cycles but also helps enhance the performance, reliability, and energy efficiency of the final product.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for using in a circuit design process, comprising:
deriving information regarding a specific cell from a cell library;
generating an initial dataset based on the information regarding the specific cell;
constructing or optimizing a machine learning model based on the initial dataset; and
generating one or more target characteristic data regarding the specific cell based on the constructed or optimized machine learning model.

2. The method of claim 1, further comprising:
generating an expanded characteristic dataset based on the one or more target characteristic data;
updating the information regarding the specific cell in the cell library based on the expanded characteristic dataset; and
utilizing the updated cell library to perform the circuit design process.

3. The method of claim 1, wherein the information regarding the specific cell includes multiple operating condition parameter values of at least one operating condition and/or multiple state parameter values of at least one state parameter of the specific cell, and characteristic data respectively corresponding to the multiple operating condition parameter values and/or the multiple state parameter values.

4. The method of claim 3, wherein the at least one operating condition corresponds to an operating temperature of the specific cell, the at least one state parameter corresponds to potentials of input terminals of the specific cell, the multiple operating condition parameter values correspond to multiple operating temperature values of the specific cell, the multiple state parameter values correspond to multiple input terminal potential values of the specific cell, and the characteristic data corresponds to multiple leakage power values.

5. The method of claim 1, wherein the step of constructing or optimizing the machine learning model based on the initial dataset comprises:
performing one or more data processing operations on the initial dataset to obtain a processed initial dataset; and
constructing or optimizing the machine learning model based on the processed initial dataset.

6. The method of claim 5, wherein the one or more data processing operations include at least one of logarithmic processing or normalization processing.

7. The method of claim 1, wherein the step of constructing or optimizing the machine learning model based on the initial dataset comprises:
training or optimizing the machine learning model under a predetermined computational resource limitation;
evaluating whether a training process or an optimization process of the machine learning model has reached a predetermined termination condition associated with the predetermined computational resource limitation; and
adjusting a learning rate of the machine learning model if the predetermined termination condition has not been reached.

8. The method of claim 7, wherein the predetermined computational resource limitation corresponds to the number of steps, the number of iterations, or elapsed time of the training process or the optimization process.

9. The method of claim 7, wherein the step of adjusting the learning rate of the machine learning model comprises:
adjusting the learning rate based on an exponential decay method.

10. The method of claim 1, wherein constructing or optimizing the machine learning model based on the initial dataset comprises:
validating consistency between the one or more target characteristic data generated by the machine learning model and the initial dataset;
determining whether a loss between the one or more target characteristic data and the initial dataset is less than a predetermined value; and
optimizing the machine learning model if the loss is greater than the predetermined value.

11. A system for using in a circuit design process, comprising:
a processor; and
a memory for storing multiple instructions, wherein when the multiple instructions are executed by the processor, the system performs the following operations:
deriving information regarding a specific cell from a cell library;
generating an initial dataset based on the information regarding the specific cell;
constructing or optimizing a machine learning model based on the initial dataset; and
generating one or more target characteristic data regarding the specific cell based on the constructed or optimized machine learning model.

12. The system of claim 11, wherein when the multiple instructions are executed by the processor, the system is caused to perform the following operations:
generating an expanded characteristic dataset based on the one or more target characteristic data;
updating the information regarding the specific cell in the cell library based on the expanded characteristic dataset; and
utilizing the updated cell library to perform the circuit design process.

13. The system of claim 11, wherein the information regarding the specific cell includes multiple operating condition parameter values of at least one operating condition and/or multiple state parameter values of at least one state parameter of the specific cell, and characteristic data respectively corresponding to the multiple operating condition parameter values and/or the multiple state parameter values.

14. The system of claim 11, wherein the at least one operating condition corresponds to an operating temperature of the specific cell, the at least one state parameter corresponds to potentials of input terminals of the specific cell, the multiple operating condition parameter values correspond to multiple operating temperature values of the specific cell, the multiple state parameter values correspond to multiple input terminal potential values of the specific cell, and the characteristic data corresponds to multiple leakage power values.

15. The system of claim 11, wherein when the multiple instructions are executed by the processor, the system is caused to perform the following operations:
performing one or more data processing operations on the initial dataset to obtain a processed initial dataset; and
constructing or optimizing the machine learning model based on the processed initial dataset.

16. The system of claim 15, wherein the one or more data processing operations include at least one of logarithmic processing or normalization processing.

17. The system of claim 11, wherein when the multiple instructions are executed by the processor, the system is caused to perform the following operations:
training or optimizing the machine learning model under a predetermined computational resource limitation;
evaluating whether a training process or an optimization process of the machine learning model has reached a predetermined termination condition associated with the predetermined computational resource limitation; and
adjusting a learning rate of the machine learning model if the predetermined termination condition has not been reached.

18. The system of claim 17, wherein the predetermined computational resource limitation corresponds to the number of steps, the number of iterations, or elapsed time of the training process or the optimization process.

19. The system of claim 11, wherein when the multiple instructions are executed by the processor, the system is caused to perform the following operations:
adjusting the learning rate based on an exponential decay method.

20. The system of claim 11, wherein when the multiple instructions are executed by the processor, the system is caused to perform the following operations:
validating consistency between the one or more target characteristic data generated by the machine learning model and the initial dataset;
determining whether a loss between the one or more target characteristic data and the initial dataset is less than a predetermined value; and
optimizing the machine learning model if the loss is greater than the predetermined value.
